(19) United States
(12) Patent Application Publication
(10) Pub. No.: US 2017/0187814 A1
(43) Pub. Date: Jun. 29, 2017

(54) MANAGING APPARATUS AND MANAGING METHOD FOR NETWORK TRAFFIC

(71) Applicant: ELECTRONICS AND TELECOMMUNICATIONS RESEARCH INSTITUTE, Daejeon (KR)

(72) Inventor: Sang Kil PARK, Daejeon (KR)

(21) Appl. No.: 15/236,721

(22) Filed: Aug. 15, 2016

(30) Foreign Application Priority Data
Dec. 28, 2015 (KR) 10-2015-0187046

(51) Int. Cl. H04L 29/08; H04L 29/06; H04L 12/26

(52) U.S. Cl. CPC H04L 67/22; H04L 67/02; H04L 43/028; H04L 67/42

(57) ABSTRACT

A managing apparatus for network traffic includes: a first traffic control engine determining whether to perform secondary analysis by primarily analyzing a packet and transferring the packet of which the secondary analysis will be performed to a second traffic control engine associated with a service server to which the packet will be transmitted; and a plurality of second traffic control engines performing the secondary analysis of the packet of which the secondary analysis is required among the packets transferred from the first traffic control engine and transferring the packet to be transferred to the service server to the first traffic control engine according to a result of performing the secondary analysis.

### CROSS-REFERENCE TO RELATED APPLICATIONS

This application claims priority to and the benefit of Korean Patent Application No. 10-2015-0187046 filed in the Korean Intellectual Property Office on Dec. 28, 2015, the entire contents of which are incorporated herein by reference.

### BACKGROUND OF THE INVENTION

1. Field of the Invention

The present invention relates to a managing apparatus and a managing method for network traffic.

2. Description of Related Art

A method for analyzing traffic in a network includes an off-line analysis method such as Hadoop based traffic analysis and an analysis method providing direct control through real-time detailed analysis for traffic in-line. As the real-time analysis method for the traffic, a deep packet inspection (DPI) method may be primarily used and the DPI means a technology that basically determines even contents in a packet.

The method is used due to a limit of a transport control protocol (TCP) on the Internet. That is, the TCP serves to control a flow of data and guarantee the data to successfully reach a counterpart so that all data are well transmitted among hosts, but does not have a mechanism to individually limit the number of connection paths per host.

Therefore, when a specific application uses multiple paths, connection of an application using a single path becomes disadvantageous, and as a result, it may be difficult or impossible to use an application of which real-time transmission is important even though a transmission speed is not high.

### SUMMARY OF THE INVENTION

The present invention has been made in an effort to provide a managing apparatus and a managing method for network traffic which can enhance stability and/or efficiency of a system and a server.

The technical objects of the present invention are not limited to the aforementioned technical objects, and other technical objects, which are not mentioned above, will be apparently appreciated to a person having ordinary skill in the art from the following description.

An exemplary embodiment of the present invention provides a managing apparatus for network traffic, including: a first traffic control engine determining whether to perform secondary analysis by primarily analyzing a packet and transferring the packet of which the secondary analysis will be performed to a second traffic control engine associated with a service server to which the packet will be transmitted; and a plurality of second traffic control engines performing the secondary analysis of the packet of which the secondary analysis is required among the packets transferred from the first traffic control engine and transferring the packet to be transferred to the service server to the first traffic control engine according to a result of performing the secondary analysis.

The first traffic control engine may include a first packet analyzing unit performing the primary analysis by using header information of the packet, a first traffic processing unit discarding the packet when the packet is an abnormal packet, transferring the packet to the second traffic control engine associated with the service server for the secondary analysis when transmission destination information of the packet matches the service server, and transferring the packet to a network when the transmission destination information of the packet does not match the service server, based on the primary analysis result, and a bandwidth controlling unit controlling a transmission bandwidth of the packet transferred to the network or the packet transferred from the plurality of second traffic control engines.

The header information may include at least any one of source IP address information, destination IP address information, source port information, destination port information, and protocol information of the packet.

The bandwidth controlling unit may control the transmission bandwidth of the packet based on a predetermined bandwidth with respect to a service server associated with the packet transferred from the plurality of second traffic control engines.

Each of the plurality of second traffic control engines may include a second packet analyzing unit performing the secondary analysis by using the header information of the packet, and a second traffic processing unit discarding the packet when the packet is the abnormal packet based on the secondary analysis result, verifying the destination IP information and the destination port information of the packet, and transferring the packet to the first traffic control engine.

Another exemplary embodiment of the present invention provides a managing method for network traffic, including: determining whether to perform secondary analysis by primarily analyzing a packet; transferring the packet of which the secondary analysis will be performed to a second traffic control engine associated with a service server to which the packet will be transmitted; performing the secondary analysis of the packet of which the secondary analysis is required among the transferred packets; and transferring the packet to be transferred to the service server to the first traffic control engine according to a result of performing the secondary analysis.

In the determining whether to perform the secondary analysis by primarily analyzing the packet, the primary analysis may be performed by using header information of the packet. The header information may include at least any one of source IP address information, destination IP address information, source port information, destination port information, and protocol information of the packet.

In the transferring of the packet of which the secondary analysis will be performed to the second traffic control engine associated with the service server to which the packet will be transmitted, the packet may be transferred to the second traffic control engine associated with the service server when transmission destination information of the packet matches the service server, based on the primary analysis result.

The managing method may further include controlling a transmission bandwidth of the packet transferred to the first traffic control engine.

In the controlling of the transmission bandwidth of the packet transferred to the first traffic control engine, the transmission bandwidth of the packet may be controlled based on a bandwidth preset with respect to the service server.

In the performing of the secondary analysis of the packet of which the secondary analysis is required among the transferred packets, the secondary analysis may be performed by using the header information of the packet.

According to exemplary embodiments of the present invention, a managing apparatus and a managing method for network traffic, secondary analysis is not performed with respect to all packets (that is, all traffic) transferred from a network and selectively performed with respect to all packets to reduce waste of system resources.

According to the exemplary embodiments of the present invention, the managing apparatus and the managing method for network traffic control the transmission bandwidths of packets retransferred to the network to efficiently use the system resources, improve stability of a service provided by each service server, and provide a stable service to users.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a block diagram of a managing apparatus for network traffic according to an exemplary embodiment of the present invention.

FIG. 2 is a block diagram of a first traffic control engine of the managing apparatus for network traffic according to the exemplary embodiment of the present invention.

FIG. 3 is a block diagram of a second traffic control engine of the managing apparatus for network traffic according to the exemplary embodiment of the present invention.

FIG. 4 is a flowchart of a managing method for network traffic according to an exemplary embodiment of the present invention.

FIG. 5 is a flowchart illustrating, in more detail, some steps of the managing method for network traffic according to the exemplary embodiment of the present invention.

FIG. 6 is a block diagram of a computing system executing a managing method for network traffic according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as ideal meaning or excessively formal meanings unless clearly defined in the present application.

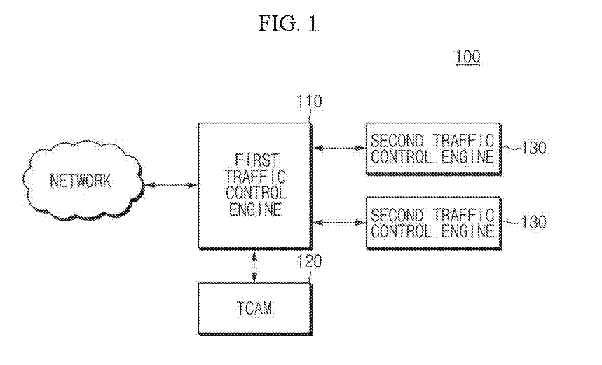

FIG. 1 is a block diagram of a managing apparatus for network traffic according to an exemplary embodiment of the present invention.

Referring to FIG. 1, the network traffic managing apparatus 100 according to the exemplary embodiment of the present invention may include a first traffic control engine 110, a TCAM 120, and a plurality of second traffic control engines 130.

The first traffic control engine 110 primarily analyzes a packet received from a network to determine whether to perform secondary analysis.

The first traffic control engine 110 may transfer a packet to be secondarily analyzed to the second traffic control engine associated with a service server (not illustrated) to which the packet will be transmitted among the plurality of second traffic control engines 130 based on a primary analysis result. The first traffic control engine 110 may discard the packet when the packet is an abnormal packet based on the primary analysis result. Herein, the abnormal packet may mean a packet including abnormal header data, but the present invention is not limited thereto and all packets which may not serve as a normal packet due to a fault which occurs during transmission/reception, parsing, and discovery operations may be used without a limit. The first traffic control engine 110 may transfer the packet to the network again based on the primary analysis result.

The first traffic control engine 110 may receive the packet of which the secondary analysis is completed from the second traffic control engine 130 again. The first traffic control engine 110 may control a transmission bandwidth of the packet transferred to the network again or the packet transferred from the second traffic control engine 130 based on the primary analysis result. For example, the first traffic control engine 110 appropriately controls transmission bandwidths of different packets (for example, packets for different application services) transmitted to the same service server to reduce an influence the traffic of the packet in which traffic of packets transmitted through a plurality of paths is transmitted through a single path.

The TCAM 120 may provide a criterion for the first traffic control engine 110 to perform the primary analysis. For example, the first traffic control engine 110 may filter the packet by performing MAC address matching of the packet through the TCAM 120. Therefore, it is possible to respond to a traffic attack such as MAC Flooding. For example, the first traffic control engine 110 may perform the primary analysis of the packet when an MAC address of the packet transferred from the network does not correspond to a predetermined rule.

The plurality of second traffic control engines 130 may perform the secondary analysis of the packet of which the secondary analysis is required among the packets transferred from the first traffic control engine 110. The plurality of second traffic control engines 130 may be configured for each service server (not illustrated). For example, the service server (not illustrated) may mean a server that provides a service (or contents, data, a material, an application service, and the like) corresponding to a request included in the packet.

The second traffic control engine 130 may verify information (e.g., analysis of the provided service, analysis of the service server to be transferred, and the like) on the packet through the secondary analysis. For example, the second traffic control engine 130 may discard the packet when the packet is the abnormal packet based on the secondary analysis result.

As described above, the first traffic control engine 110 may transfer the packet of which secondary analysis is required to the second traffic control engine 130 associated with the service server to which the packet is transferred. Therefore, the secondary analysis is not performed with respect to all packets (that is, all traffic) transferred from the network and selectively performed with respect to all packets to reduce waste of system resources.

The first traffic control engine 110 controls the transmission bandwidths of the packets retransferred to the network to efficiently use the system resources, improve the stability of the service provided by each service sever, and provide a stable service to the users.

Hereinafter, the first traffic control engine 110 and the plurality of second traffic control engines 130 will be described in more detail.

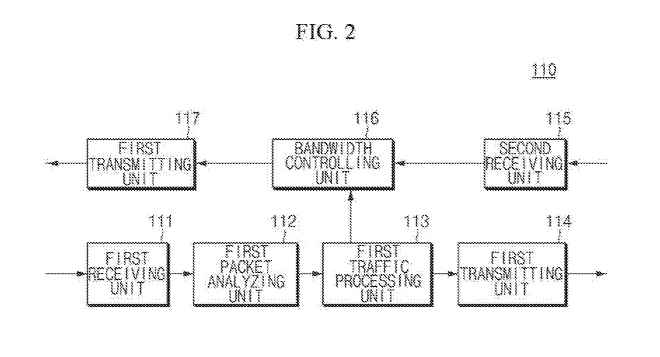

FIG. 2 is a block diagram of a first traffic control engine of the managing apparatus for network traffic according to the exemplary embodiment of the present invention.

Referring to FIG. 2, the first traffic control engine 110 may include a first receiving unit 111, a first packet analyzing unit 112, a first traffic processing unit 113, a second transmitting unit 114, a second receiving unit 115, a bandwidth controlling unit, and a first transmitting unit 117.

The first receiving unit 111 may receive the packet from the network. For example, the first receiving unit 111 may store the received packet in an AsyncFIFO memory. The first receiving unit 111 may transfer the received packet to the first packet analyzing unit 112.

The first packet analyzing unit 112 may perform the primary analysis by using header information of the packet. For example, the header information of the packet may include at least any one of source IP address information, destination IP address information, source port information, destination port information, and protocol information. The first packet analyzing unit 112 may perform the primary analysis by parsing and detecting the packet.

The first traffic processing unit 113 may discard the packet when the packet is the abnormal packet based on the primary analysis result.

The first traffic processing unit 113 may transfer the packet to the second traffic control engine 130 associated with the service server for the secondary analysis when transmission destination information (for example, the destination port information) of the packet matches the service server (for example, predetermined port information for the service server).

That is, the first traffic processing unit 113 may verify the transmission destination information of the packet based on the header information of the packet analyzed by the first packet analyzing unit 112 and transfer the packet to the second traffic control engine 130 associated with the service server to which the packet will be transmitted. To this end, the first traffic processing unit 113 may transfer the packet to the second transmitting unit 114.

The first traffic processing unit 113 may transfer the packet to the network when the transmission destination information of the packet does not match the service server. To this end, the first traffic processing unit 113 may transfer the packet to the bandwidth controlling unit 116.

The second transmitting unit 114 may transfer the packet transferred from the first traffic processing unit 113 to the second traffic control engine 130. For example, the second transmitting unit 114 may store the transferred packet in the AsyncFIFO memory.

The second receiving unit 115 may receive the packet from the second traffic control engine 130. For example, the second receiving unit 115 may store the received packet in the AsyncFIFO memory.

The bandwidth controlling unit 116 may control the transmission bandwidth of the packet transferred from the first traffic processing unit 113 and/or the packet received from the second traffic control engine 130 through the second receiving unit 115. For example, the bandwidth controlling unit 116 may control the transmission bandwidth of the packet received from the second traffic control engine 130 based on a predetermined transmission bandwidth preset for each service server.

The first transmitting unit 117 may transfer the packet transferred from the bandwidth controlling unit 116 to the network. The first transmitting unit 117 may store the transferred packet in the AsyncFIFO memory.

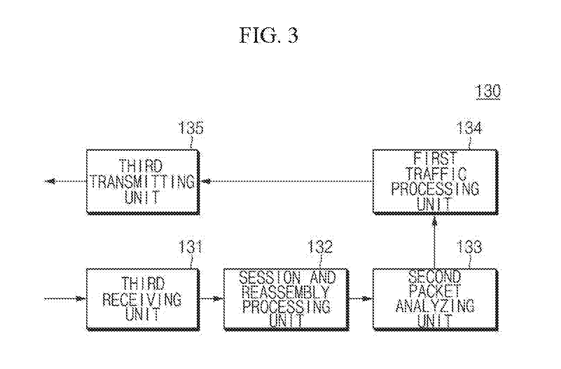

FIG. 3 is a block diagram of a second traffic control engine of the managing apparatus for network traffic according to the exemplary embodiment of the present invention.

Referring to FIG. 3, the second traffic control engine 130 according to the exemplary embodiment of the present invention may include a third receiving unit 131, a session and reassembly processing unit 132, a second packet analyzing unit 133, a second traffic processing unit 134, and a third transmitting unit 135.

The third receiving unit 131 may receive the packet from the first traffic control engine 110. The third receiving unit 131 may store the transferred packet in the AsyncFIFO memory.

The session and reassembly processing unit 132 may manage a session so that all received packets are compatible with the second traffic control engine 130. Herein, the session management may mean controlling a structure for communication among different sessions and further, mean managing connection or connection termination by making the sessions which mutually communicate with each other be compatible with each other. The session and reassembly processing unit 132 may reassemble the packet so as to determine contents in an application layer constituted by each packet.

The second packet analyzing unit 133 may perform the secondary analysis by using the header information of the packet. For example, the header information of the packet may include at least any one of source IP address information, destination IP address information, source port information, destination port information, and protocol information. The second packet analyzing unit 133 may perform the secondary analysis by parsing and detecting the packet.

The second traffic processing unit 134 may verify information (e.g., analysis of the provided service, analysis of the service server to be transferred, and the like) on the packet based on the secondary analysis result. For example, the second traffic processing unit 134 may verify the destination IP information and the destination port information of the packet and retransfer the packet to the first traffic control engine. To this end, the second traffic processing unit 134 may transfer the packet to the third transmitting unit 135. The second traffic processing unit 134 may discard the packet when the packet is the abnormal packet based on the secondary analysis result.

The third transmitting unit 135 may transfer the packet transferred from the second traffic processing unit 134 to the first traffic control engine 110. The third transmitting unit 135 may store the transferred packet in the AsyncFIFO memory.

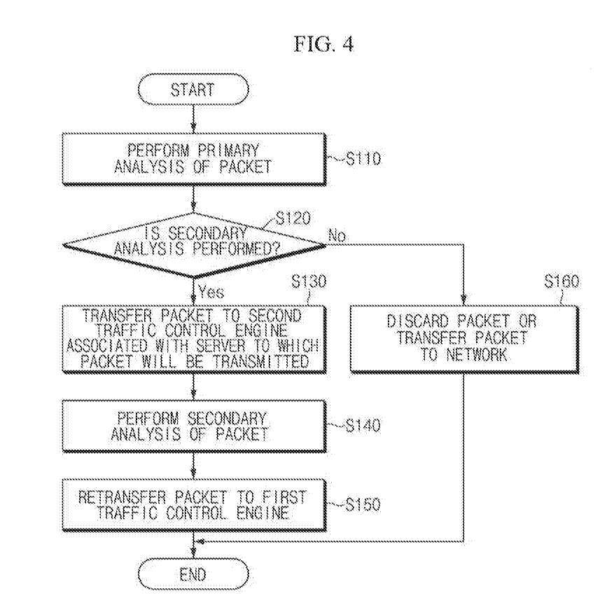

FIG. 4 is a flowchart of a managing method for network traffic according to an exemplary embodiment of the present invention.

Referring to FIG. 4, the managing method for network traffic according to the exemplary embodiment of the present invention may include performing primary analysis of a packet (S110), determining whether to perform secondary analysis of the packet (S120), transferring the packet to a second traffic control engine associated with a server to which the packet will be transferred (S130), performing the secondary analysis of the packet (S140), and retransferring the packet to a first traffic control engine (S150).

Meanwhile, as a result of the determination in step S120, the managing method may include discarding a packet of which the secondary analysis for the packet is determined not to be performed or transferring the packet to a network (S160).

Hereinafter, steps S110 to S160 will be described in more detail with reference to FIGS. 1 to 3.

In step S110, the first traffic control engine 110 may perform the primary analysis of the packet received from the network. In detail, the first packet analyzing unit 112 may perform the primary analysis by using the header information of the packet. For example, the header information of the packet may include at least any one of source IP address information, destination IP address information, source port information, destination port information, and protocol information. The first packet analyzing unit 112 may perform the primary analysis by parsing and detecting the packet.

In step S120, the first traffic control engine 110 may determine whether to perform the secondary analysis of the packet based on the primary analysis result. In detail, the first traffic processing unit 113 may determine whether to perform the secondary analysis of the packet based on the primary analysis result.

In step S130, the first traffic control engine 110 may transfer the packet to the second traffic control engine associated with a service server (not illustrated) to which the packet will be transmitted among the plurality of second traffic control engines 130.

In detail, the first traffic processing unit 113 may transfer the packet to the second traffic control engine 130 associated with the service server for the secondary analysis when transmission destination information (for example, the destination port information) of the packet matches the service server (for example, predetermined port information for the service server).

That is, the first traffic processing unit 113 may verify the transmission destination information of the packet based on the header information of the packet analyzed by the first packet analyzing unit 112 and transfer the packet to the second traffic control engine 130 associated with the service server to which the packet will be transmitted. To this end, the first traffic processing unit 113 may transfer the packet to the second transmitting unit 114.

In step S140, the second traffic control engine 130 may perform the secondary analysis of the packet of which the secondary analysis is required among the packets transferred from the first traffic control engine 110. The plurality of second traffic control engines 130 may be configured for each service server (not illustrated). For example, the service server (not illustrated) may mean a server that provides a service (or contents, data, a material, an application service, and the like) corresponding to a request included in the packet.

The second traffic control engine 130 may verify information (e.g., analysis of the provided service, analysis of the service server to be transferred, and the like) on the packet through the secondary analysis. For example, the second traffic control engine 130 may discard the packet when the packet is the abnormal packet based on the secondary analysis result. A detailed secondary analysis process of the second traffic control engine 130 may be substantially the same as described with reference to FIG. 3.

In step S150, the first traffic control engine 110 may receive the packet of which the secondary analysis is completed from the second traffic control engine 130 again.

Thereafter, the first traffic control engine 110 may control the transmission bandwidth of the packet transferred to the network again or the packet transferred from the second traffic control engine 130 based on the primary analysis result.

In step S160, the first traffic control engine 110 may discard the packet when the packet is the abnormal packet based on the primary analysis result. The first traffic control engine 110 may transfer the packet to the network again based on the primary analysis result.

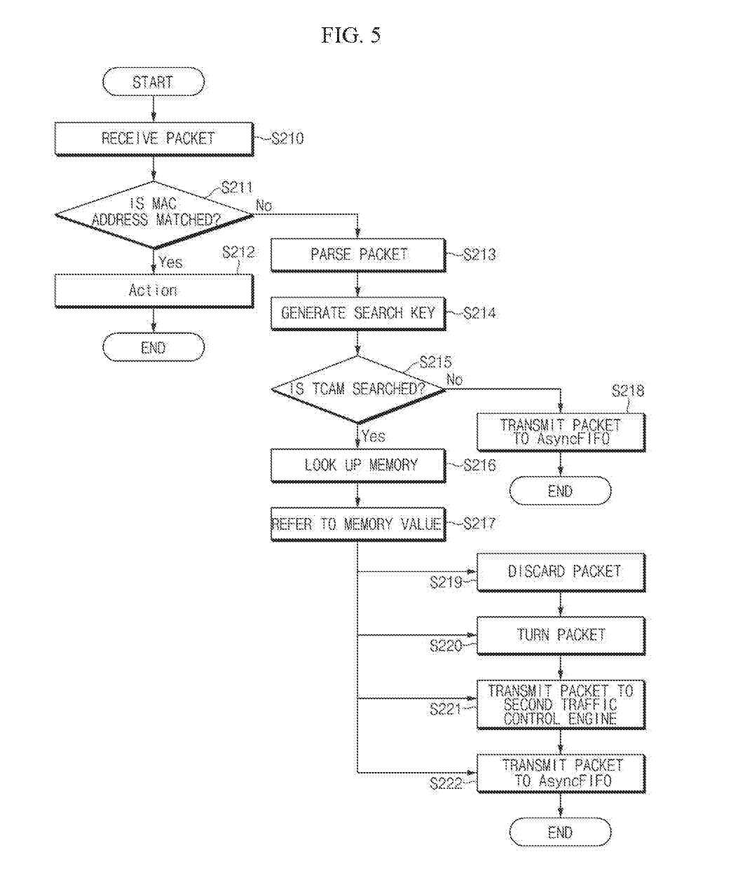

FIG. 5 is a flowchart illustrating, in more detail, some steps of the managing apparatus for network traffic according to the exemplary embodiment of the present invention.

Referring to FIG. 5, a traffic processing process of the first traffic control engine 110 is illustrated in more detail.

The first traffic control engine 110 may receive the packet (S210). The first traffic control engine 110 may perform MAC address matching for a procedure (S211) for solving an attack such as MAC flooding and perform an operation (S212) such as packet discarding, or the like when the attack needs to be interrupted based on MAC flooding or an MAC address as a result of performing the MAC address matching.

The first packet analyzing unit 112 of the first traffic control engine 110 may remove an MAC header of an input packet and extract an L3 packet and thereafter, parse the packet for information on IP Header/TCP, UDP, ICMP, and the like when the MAC address does not conform with a rule (S213).

The first traffic processing unit 113 may generate a search key for inquiring a classification device constituted by a TCAM or a memory based on packet data extracted trough the packet parsing (S213) (S214). Look-up may be performed with respect to a packet classification rule by using the generated search key (S215).

When a corresponding index is present as a result of performing the look-up for the packet classification rule (S216), the first traffic processing unit 113 may fetch a separate memory address indicated by the index (S217).

When the corresponding index is not present as a result of inquiring the TCAM, the first traffic processing unit 113 may transmit and store the packet to and in AsyncFIFO of the first transmitting unit 117 through the bandwidth controlling unit 116 in order to transmit the packet through the network in respect to the packet (S218). Thereafter, the packet stored in the AsyncFIFO may be transferred to the network.

The first traffic processing unit 113 may fetch an address based on the index by the TCAM search result and thereafter, perform traffic processing such as packet discarding (S219), packet retransmission to the network (S220), packet transmissions to any one of the plurality of second traffic control engines 130 (S221), packet transmission to the first transmitting unit 117 (S222), and the like by a case defined in advancebased on a value of the corresponding memory (S217) in advance.

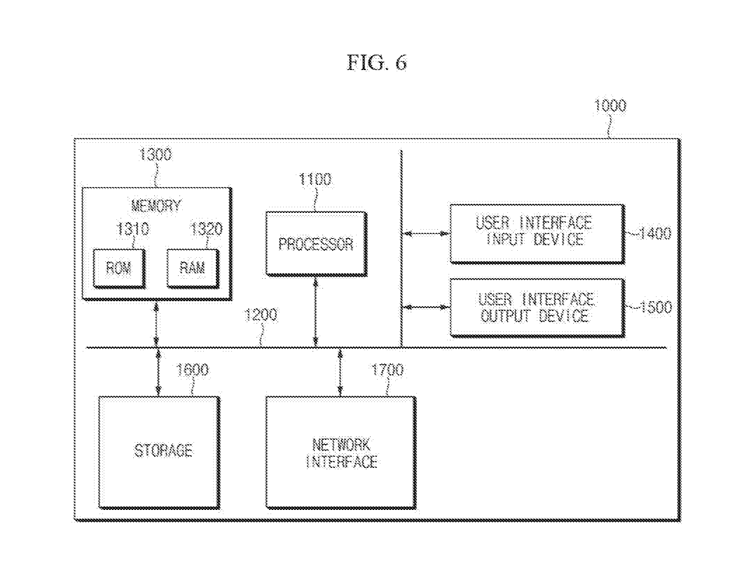

FIG. 6 is a block diagram of a computing system executing a managing method for network traffic according to an exemplary embodiment of the present invention.

Referring to FIG. 6, the computing system 1000 may include at least one processor 1100, a memory 1300, a user interface input device 1400, a user interface output device 1500, a storage 1600, and a network interface 1700 connected through a system bus 1200.

The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and % or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

The above description just illustrates the technical spirit of the present invention and various changes and modifications can be made by those skilled in the art to which the present invention pertains without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

What is claimed is:

1. A managing apparatus for network traffic, the managing apparatus comprising:
a first traffic control engine determining whether to perform secondary analysis by primarily analyzing a packet and transferring the packet of which the secondary analysis will be performed to a second traffic control engine associated with a service server to which the packet will be transmitted; and
a plurality of second traffic control engines performing the secondary analysis of the packet of which the secondary analysis is required among the packets transferred from the first traffic control engine and transferring the packet to be transferred to the service server to the first traffic control engine according to a result of performing the secondary analysis.

2. The managing apparatus of claim 1, wherein the first traffic control engine includes
a first packet analyzing unit performing the primary analysis by using header information of the packet,
a first traffic processing unit discarding the packet when the packet is an abnormal packet, transferring the packet to the second traffic control engine associated with the service server for the secondary analysis when transmission destination information of the packet matches the service server, and transferring the packet to a network when the transmission destination information of the packet does not match the service server, based on the primary analysis result, and
a bandwidth controlling unit controlling a transmission bandwidth of the packet transferred to the network or the packet transferred from the plurality of second traffic control engines.

3. The managing apparatus of claim 2, wherein the header information includes at least any one of source IP address information, destination IP address information, source port information, destination port information, and protocol information of the packet.

4. The managing apparatus of claim 2, wherein the bandwidth controlling unit controls the transmission bandwidth of the packet based on a predetermined bandwidth with respect to a service server associated with the packet transferred from the plurality of second traffic control engines.

5. The managing apparatus of claim 1, wherein each of the plurality of second traffic control engines includes
a second packet analyzing unit performing the secondary analysis by using the header information of the packet, and
a second traffic processing unit discarding the packet when the packet is the abnormal packet based on the secondary analysis result, verifying the destination IP information and the destination port information of the packet, and transferring the packet to the first traffic control engine.

6. A managing method for network traffic, the managing method comprising:
determining whether to perform secondary analysis by primarily analyzing a packet;
transferring the packet of which the secondary analysis will be performed to a second traffic control engine associated with a service server to which the packet will be transmitted;
performing the secondary analysis of the packet of which the secondary analysis is required among the transferred packets; and
transferring the packet to be transferred to the service server to the first traffic control engine according to a result of performing the secondary analysis.

7. The managing method of claim 6, wherein in the determining whether to perform the secondary analysis by primarily analyzing the packet, the primary analysis is performed by using header information of the packet.

8. The managing method of claim 7, wherein the header information includes at least any one of source IP address information, destination IP address information, source port information, destination port information, and protocol information of the packet.

9. The managing method of claim 6, wherein in the transferring of the packet of which the secondary analysis will be performed to the second traffic control engine associated with the service server to which the packet will be transmitted, the packet is transferred to the second traffic control engine associated with the service server when transmission destination information of the packet matches the service server, based on the primary analysis result.

10. The managing method of claim 6, further comprising:
controlling a transmission bandwidth of the packet transferred to the first traffic control engine.

11. The managing method of claim 10, wherein in the controlling of the transmission bandwidth of the packet transferred to the first traffic control engine, the transmission bandwidth of the packet is controlled based on a bandwidth preset with respect to the service server.

12. The managing method of claim 6, wherein in the performing of the secondary analysis of the packet of which the secondary analysis is required among the transferred packets, the secondary analysis is performed by using the header information of the packet.
